(19) United States
(12) Patent Application Publication
(10) Pub. No.: US 2013/0346174 A1
(43) Pub. Date: Dec. 26, 2013

(54) COUPON STACKING FOR SCENARIOS INCLUDING SOCIAL NETWORKING

(71) Applicants: Pragyana K. Mishra, Bellevue, WA (US); Nagendra Kolluru, Redmond, WA (US)

(72) Inventors: Pragyana K. Mishra, Bellevue, WA (US); Nagendra Kolluru, Redmond, WA (US)

(73) Assignee: Microsoft Corporation, Redmond, WA (US)

(21) Appl. No.: 13/531,387

(22) Filed: Jun. 22, 2012

(51) Int. Cl. G06Q 30/02

(52) U.S. Cl. 705/14.23

(57) ABSTRACT

A transaction server may enable users to purchase goods and services from vendors, and may receive and fulfill coupons applied to the transactions. In some scenarios, the transaction server may only accept one coupon per transaction, or may accept multiple coupons for a transaction that are separately and independently applied to the transaction. However, in other scenarios, a coupon may alter the effect of another coupon on the transaction (e.g., doubling a discount presented by another coupon). Accordingly, the transaction server may be configured to apply a base coupon to the transaction, and alter the effect of the base coupon on the transaction according to an auxiliary coupon. In many such scenarios, the transaction may involve individuals in a social network (e.g., a user presenting the base coupon, and an individual in the user's social network presenting the auxiliary coupon in order to participate in the same transaction).

### BACKGROUND

In the field of computing, many scenarios involve coupons for transactions between a vendor and a user. For example, an e-commerce service may provide a transaction server that is configured to present offers for goods and services to users; to complete transactions by charging users and allocating purchased goods and services for the users. Such transaction servers may be further configured to adjust the transactions based on gift cards, discount codes, or post-transaction rebates that alter the cost and/or quality or quantity of delivered. A transaction server may be further configured to distribute coupons to specific users (e.g., by storing a list of email addresses of former customers, and emailing the customers with a coupon code to persuade the user to engage in a transaction) and/or to verify the eligibility of a coupon to a particular transaction (e.g., verifying that a user engaging in a transaction is the same user to whom the coupon was distributed).

More specifically, the transaction server may evaluate the presentation of multiple coupons for a transaction in several ways. As a first example, the transaction server may enforce restrictions on the application of multiple coupons to a transaction (e.g., by allowing only one coupon for each transaction). As a second example, the transaction server may apply two or more coupons independently to the same transaction; e.g., a first coupon for 10% off the cost of a transaction for a product, and a second coupon that adds a free accessory for the same product, may be separately applied to confer the value of both coupons upon the same transaction. In both scenarios, the transaction server may separately evaluate the eligibility of each coupon upon the transaction, and may separately alter the transaction to reflect the application of eligible coupons to the separate coupons.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

While the application of separate coupons to a transaction may be appealing, a separate coupon scenario may enable some coupons to alter the effect of other coupons on a particular transaction. For example, a base coupon may be presented that presents a first effect on a transaction; and an auxiliary coupon may be presented that, instead of directly altering the transaction, alters the effect of the base coupon on the transaction. That is, the auxiliary coupon may not specify any direct impact on the value of the transaction and may be inapplicable to the transaction when presented in isolation, but may increase a discount of the base coupon; extend the eligibility of the base coupon to other individuals; and/or raise the quality or quantity of a good or service for which a base coupon is redeemed. Rather than separately applying the base coupon and the auxiliary coupon to the same or different transactions, the transaction server may be configured to, upon receiving both a base coupon and an auxiliary coupon for a transaction (either received at the same time by the same individual for a transaction for goods or services provided by the same vendor, or at different times, from different individuals, and/or for goods or services provided by different vendors), alter the transaction based on upon the base effect of the base coupon as altered by the auxiliary effect of the auxiliary coupon.

Some variations of this technique may be particularly relevant to users who participate in a social group that identifies relationships between the user and other individuals. As a first example, the base coupon may be presented to the user, and the auxiliary coupon may be presented to a different individual within the user's social group that, if submitted to the transaction server within a specified period, affects the effect of the base coupon on the transaction for the first user. As a second example, the base coupon may be distributed to a user, and the auxiliary coupon may also be presented to the user for redelivery to any other individual within the user's social group, such that if the other individual submits the auxiliary coupon, both the user and the other individual may engage in the transaction altered by the base coupon as affected by the auxiliary coupon. Additionally, the user who persuaded the other individual to engage in the transaction may receive a further discount to incentivize the persuasion of the other individual. As a third example, the transaction server may extend the base coupon and the auxiliary coupon to several or all users of the user's social group; may progressively alter the transaction for each additional individual of the social group who joins the transaction; and may notify the social group of the redemption of the base coupon and/or auxiliary coupon (e.g., “12 out of 20 users in this social group have engaged in the transaction”) in order to persuade additional individuals of the social group to join. These and other configurations of the transaction server may enable various types and effects of base coupons and auxiliary coupons in accordance with the techniques presented herein.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary scenario featuring a set of coupons applied to a transaction by a transaction server.

FIG. 2 is an illustration of an exemplary scenario featuring a set of coupons applied to a transaction by a transaction server in accordance with the techniques presented herein.

FIG. 3 is a flow chart illustrating an exemplary method of applying a set of coupons to a transaction in accordance with the techniques presented herein.

FIG. 4 is an illustration of an exemplary computer-readable medium comprising processor-executable instructions configured to embody one or more of the provisions set forth herein.

FIG. 5 is an illustration of an exemplary scenario featuring a set of coupons applied to a transaction involving a plurality of vendors.

FIG. 6 is an illustration of an exemplary scenario featuring a set of coupons applicable to transactions distributed to a set of users in a social group.

FIG. 7 is an illustration of exemplary scenarios featuring coupons presented by individuals in a social group and applied to a transaction by a transaction server.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

### A. Introduction

Within the field of computing, many scenarios involve a transaction executed by a transaction server for the exchange of goods and service provided by one or more vendors. As a first example, an e-commerce server may provide a virtual store that enables users to browse a set of goods and services that are available at various costs, make some selections, and request a completion of the transaction (e.g., by allocating the selected goods and services for provision to the user, and/or by charging the user for the cost of the transaction). As a second example, an auction server may enable users to engage in an auction commerce model in order to formulate commitments to exchange goods and services for value, and may facilitate the completion of the auction (e.g., by assisting a seller in providing goods and services to a buyer, and/or by conveying the value provided by the buyer to the seller). As a third example, a back-end business server for a brick-and-mortar store may receive orders placed by visitors, and may log the orders and charge the visitors for the cost of the order.

In these and other scenarios, the properties of the transaction may be altered by the presentation of coupons of various types. As a first example, a physical or virtual coupon may be presented that reduces the cost of a good or service, and/or that alters the quality or quantity of the good or service (e.g., an upgrade of a product to a higher-quality product, or a faster shipping period). As a second example, a gift card may be presented that covers or offsets the cost of the good or service. As a third example, a rewards service may be established where a user who completes a transaction with a vendor receives credit that may be applicable toward a future transaction (e.g., completed transactions may confer “points” to the user that may be collected and redeemed for goods and services). In these and other scenarios, the transaction server may be configured to, upon receiving a coupon to be applied to a transaction, very the applicability of the coupon to the transaction (e.g., verifying that the coupon applies to the goods and/or services presented in the transaction and has not expired), and alter the transaction in accordance with the coupon.

In many such scenarios, a user may submit a plurality of coupons to be applied to a transaction. For example, a user may possess two coupons that each specifies a reduction in price of a product of a vendor (e.g., both coupons reducing the cost of the product by 10%), and may submit both coupons for application to the same transaction. In some such scenarios, the transaction server may be configured to refuse the application of the set of coupons for the transaction (e.g., the coupons may be mutually exclusive, such that for any transaction, only one coupon may be applied). In other such scenarios, the transaction server may allow the set of coupons for the transaction, and may accept the submission by applying each coupon (concurrently or sequentially) to the transaction.

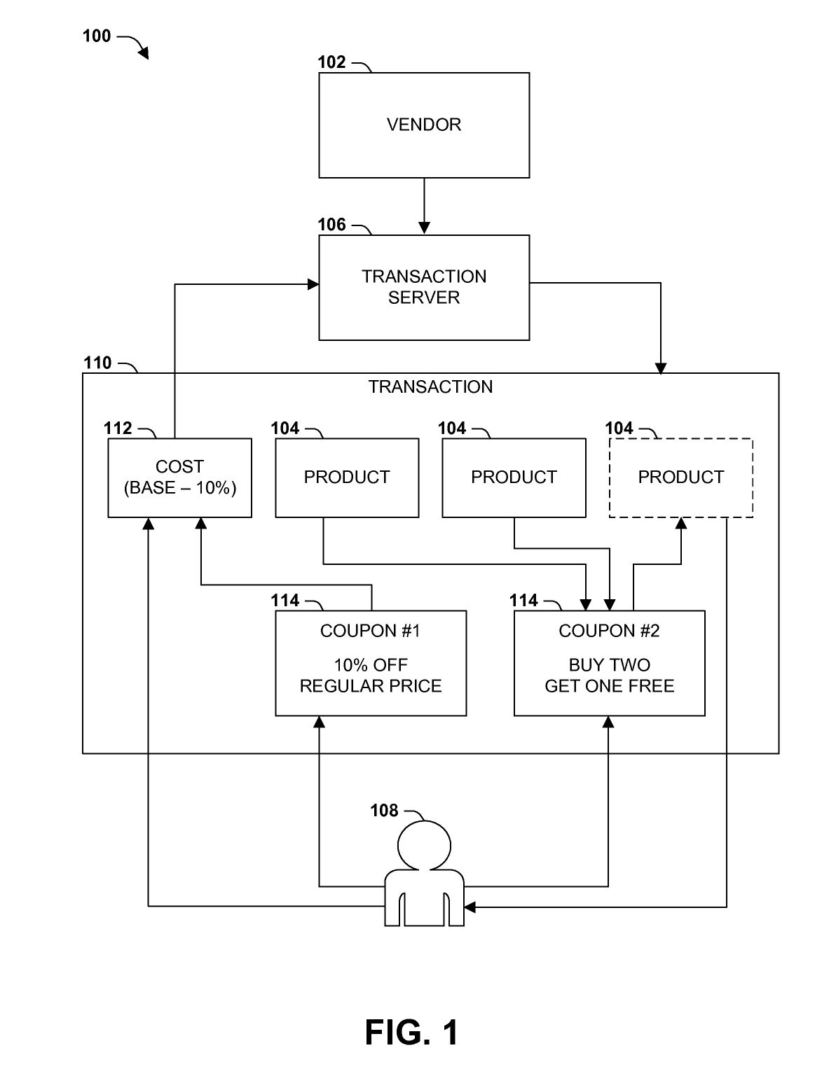

FIG. 1 presents an illustration of an exemplary scenario 100 featuring a vendor 102 of a product 104, wherein the vendor 102 provides a transaction server 106 to enable users 108 to formulate transactions 110 to purchase the product 104. The product 104 may ordinarily be offered at a particular cost 112 (e.g., a base cost such as a Manufacturer's Suggested Retail Price (MSRP)), and may advertise the product 104 to users 108 who visit the transaction server 106. When a user 108 submits a transaction 110 to purchase one or more units of the product 104 (e.g., two units in this exemplary scenario 100), the transaction server 106 may verify the availability of the units of the product 104; may charge the user 108 with the cost 112 of the product 104; may allocate the requested units of the product 104 from the inventory of the vendor 102; may arrange the delivery of the units of the product 104 to the user 108; and may record the transaction 110 in a transaction log. However, a user 108 may also submit a coupon 114 that alters the transaction 110 in various ways; and in some such scenarios, such as the exemplary scenario 100 of FIG. 1, the user 108 may submit two (or more) coupons 114 for application to the same transaction 110. For example, the user 108 may submit a first coupon 114 indicating a 10% reduction in the cost 112 of the product 104, and the transaction server 106 may fulfill the first coupon 114 by reducing the cost 112 chargeable to the user 108 for the transaction 110 by 10%. Additionally, the user 108 may submit a second coupon 114 indicating an increase in the quantity of the product 104 (e.g., a “buy two, get one free” offer), and the transaction server 106 may fulfill the second coupon 114 by confirming that the transaction 110 includes the purchase of at least two units of the product 104 and adding a third unit of the product 104 to the transaction 110. By separately testing the eligibility of each coupon 114 and altering the transaction 110 according to the terms of each submitted coupon 114, the transaction server 106 may enable the user 108 to submit multiple coupons 114 for application to the same transaction 110.

### B. Presented Techniques

While the exemplary scenario 100 of FIG. 1 enables the fulfillment of some types of coupons 114, the configuration of the transaction server 106 may limit the types of coupons permitted by such transaction 110. In particular, if the transaction server 106 separately and independently verifies and applies each coupon 114 to the transaction 110, the transaction server 106 may fulfill the application of multiple coupons for the same transaction 110, but the separation of the coupons 114 may not allow some coupons 114 to affect the value of other coupons 114 submitted for the same transaction 110. For example, in the exemplary scenario 100 of FIG. 1, each coupon 114 confers a distinct advantage on the transaction 110, but neither the coupons 114 affects the value of the other coupon 114; i.e., the advantage of each coupon 114 for the transaction 110 is not affected by whether or not the other coupon 114 is also submitted for the same transaction 110. It may be desirable to distribute coupons 114 that affect the value of other coupons 114 for the same transaction 110; e.g., a first coupon may indicate a doubling of the discount of the cost 112 offered by any other coupon 114 for the same transaction 110. In such scenarios, the first coupon may be inapplicable to the transaction 110 in isolation; e.g., if no other coupon 114 is submitted for the same transaction 110, then the transaction server 106 may be unable to apply the first coupon to the transaction 110 in a meaningful manner, since there is no discount to be doubled. However, an alternative configuration of the transaction server 106 may enable the application of coupons 114 affecting the value of other coupons 114 for the same transaction 110.

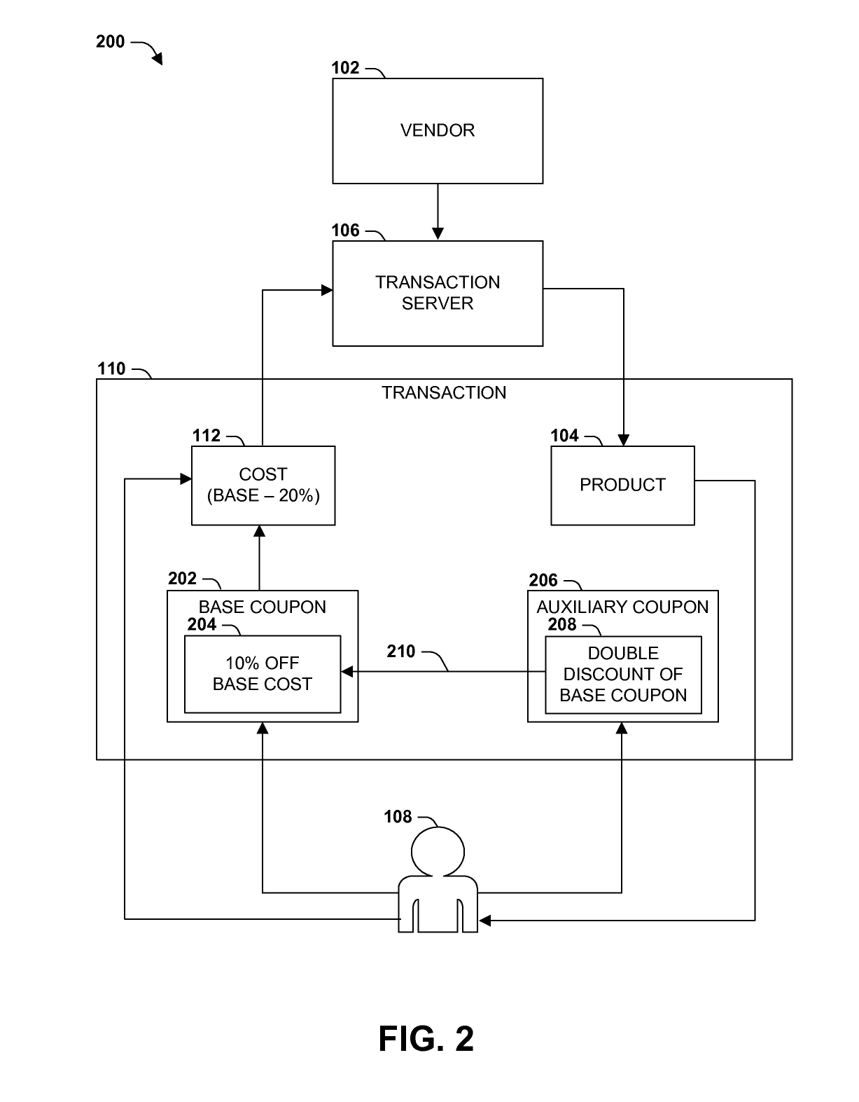

FIG. 2 presents an illustration of an exemplary scenario 200 featuring the configuration of a transaction server 106 to apply coupons not in a separate, independent manner, but in a related manner. In this exemplary scenario 200, the vendor 102 of a product 104 again provides a transaction server 106 to allow users 108 to formulate transactions 110 to purchase products 104 at a particular cost 112. However, in this exemplary scenario 200, the user 108 may submit both a base coupon 202 that affects the transaction 110, and an auxiliary coupon 206 that alters the effect of the base coupon 202 on the transaction 110. In particular, the base coupon 202 may confer a discount on the cost 112 of the product 104 (e.g., a reduction of 10% of the base cost of the product 104), and the auxiliary coupon 206 may indicate a doubling 208 of the base coupon value 204 indicated by the base coupon 202, and the transaction server 106 may alter 210 the base coupon value 204 of the base coupon 202 for the transaction 110 according to the auxiliary coupon value 208 of the auxiliary coupon 206. It may be appreciated that the auxiliary coupon 206 cannot be independently or separately applied to the transaction 110 in isolation of the base coupon 202, because the doubling 208 may be meaningless in the absence of the base coupon value 204 conferred by the base coupon 202. Thus, the transaction server 106 may be configured not to isolate the application of each coupon 114 on the transaction 110, but, instead, to alter the effect on the transaction 110 of the base coupon 202 according to the auxiliary coupon 206, in accordance with the techniques presented herein.

### C. Exemplary Embodiments

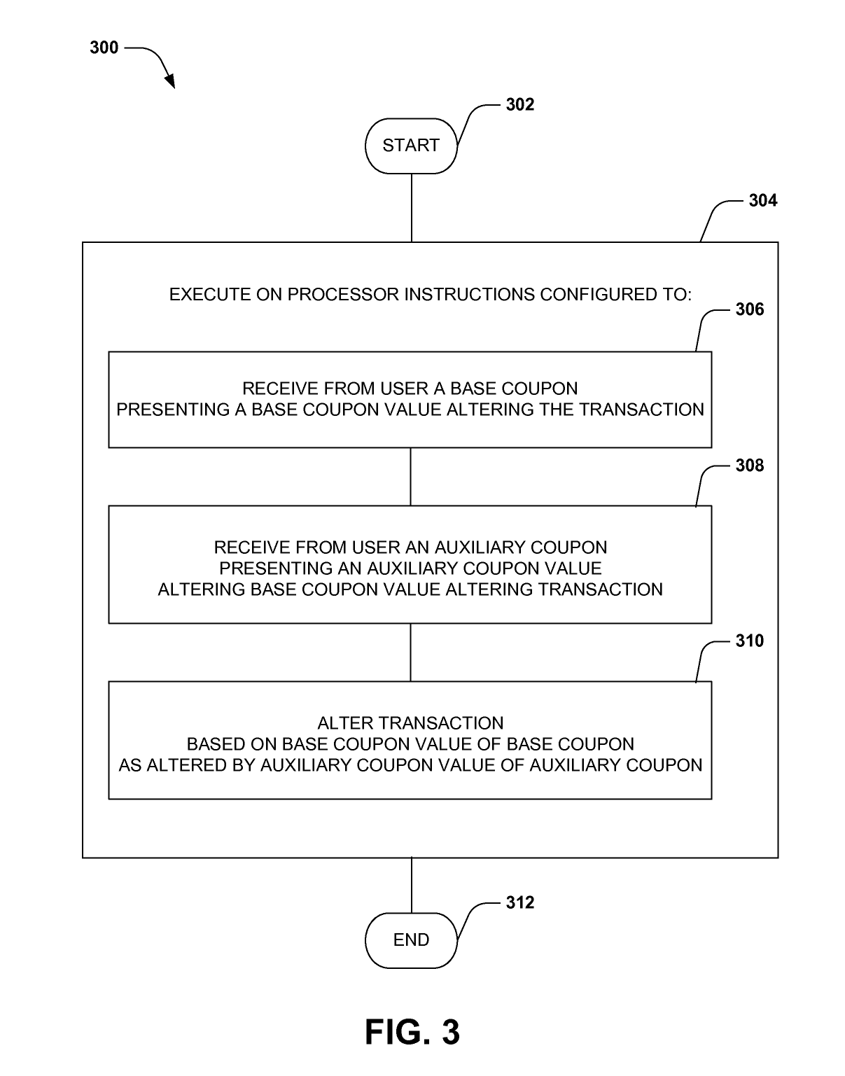

FIG. 3 presents a first exemplary embodiment of the techniques presented herein, illustrated as an exemplary method 300 of processing transactions 110 of users 108 on a computer having a processor. The instructions may be implemented, e.g., as a set of instructions stored in a memory component of the device (e.g., a memory circuit, a platter of a hard disk drive, a solid-state storage device, or a magnetic or optical disc) that, when executed on a processor of the device, causes the device to perform the techniques presented herein. The exemplary method 300 begins at 302 and involves executing 304 the instructions on the processor of the device. In particular, the instructions are configured to receive 306 from the user 108 a base coupon 202 presenting a base coupon value altering the transaction 110. The exemplary method 300 is also configured to receive 308 from the user 108 an auxiliary coupon 206 presenting an auxiliary coupon value altering the base coupon value altering the transaction 110. The instructions are also configured to, after receiving 306 the base coupon 202 and receiving 308 the auxiliary coupon 206, alter 310 the transaction 110 based on the base coupon value of the base coupon 202 as altered by the auxiliary coupon value of the auxiliary coupon 206. Having achieved the altering of the transaction 110 based on the base coupon 202 altered according to the auxiliary coupon 206, the exemplary method 300 achieved the processing of the transaction 110 according to the techniques presented herein, and so ends at 312.

Another embodiment involves a computer-readable medium comprising processor-executable instructions configured to apply the techniques presented herein. Such computer-readable media may include, e.g., computer-readable storage media involving a tangible device, such as a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD-R, DVD-R, or floppy disc), encoding a set of computer-readable instructions that, when executed by a processor of a device, cause the device to implement the techniques presented herein. Such computer-readable media may also include (as a class of technologies that are distinct from computer-readable storage media) various types of communications media, such as a signal that may be propagated through various physical phenomena (e.g., an electromagnetic signal, a sound wave signal, or an optical signal) and in various wired scenarios (e.g., via an Ethernet or fiber optic cable) and/or wireless scenarios (e.g., a wireless local area network (WLAN) such as WiFi, a personal area network (PAN) such as Bluetooth, or a cellular or radio network), and which encodes a set of computer-readable instructions that, when executed by a processor of a device, cause the device to implement the techniques presented herein.

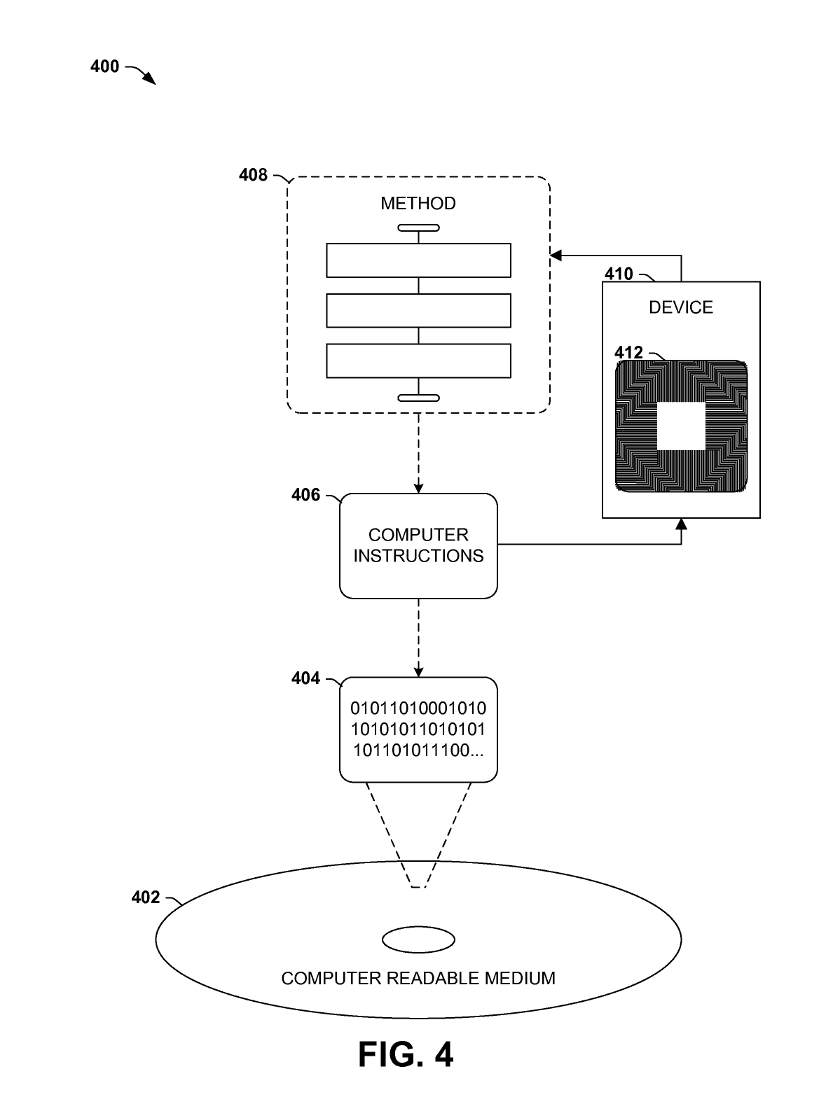

An exemplary computer-readable medium that may be devised in these ways is illustrated in FIG. 4, wherein the implementation 400 comprises a computer-readable medium 402 (e.g., a CD-R, DVD-R, or a platter of a hard disk drive), on which is encoded computer-readable data 404. This computer-readable data 404 in turn comprises a set of computer instructions 406 configured to operate according to the principles set forth herein. Some embodiments of this computer-readable medium may comprise a nontransitory computer-readable storage medium (e.g., a hard disk drive, an optical disc, or a flash memory device) that is configured to store processor-executable instructions configured in this manner that, when executed on a processor 412 of a device 410, cause the device to perform the techniques presented herein. For example, the processor-executable instructions 406 may be configured to cause the device 410 to perform a method of presenting search results in response to a search query, such as the exemplary method 300 of FIG. 3. Many such computer-readable media may be devised by those of ordinary skill in the art that are configured to operate in accordance with the techniques presented herein.

### D. Variations

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary method 300 of FIG. 3) to confer individual and/or synergistic advantages upon such embodiments.

### D1. Scenarios

A first aspect that may vary among embodiments of these techniques relates to the scenarios wherein such techniques may be implemented.

As a first variation of this first aspect, these techniques may affect many types of transactions 110 with many types of merchants, such as manufacturers of goods, providers of services, or intermediaries such as advertisers or auctioneers of goods or services. The transactions may also vary, such as a purchase, lease, trial, auction, warranty, repair, or subscription for specified goods and/or services.

As a second variation of this first aspect, these techniques may involve base coupons 202 presenting many types of base coupon values 204 for the transaction 110. For example, the base coupon value 204 may represent a reduction in the cost 112 of the transaction 110; a deferral of the cost 112 of the transaction 110 (e.g., allowing the user 108 to pay the cost 112 of the transaction 110 at a later date); including, at a free or discounted rate, a second product 104 (or service) in the transaction 110 that is related to another product 104 in the transaction 110 (e.g., providing an accessory or warranty for the primary product 104 in the transaction 110); providing a product 104 to the user 108 at a faster pace (e.g., expedited shipping on a delivery of a product 104); upgrading a product 104 of the transaction 110 to a higher-quality product 104; or increasing a quantity of a product 104 in the transaction 110 at less than a proportional increase of the cost 112 (e.g., a “buy one, get one at a 50% discount” base coupon value 204).

As a third variation of this first aspect, these techniques may involve auxiliary coupons 206 presenting many types of auxiliary coupon values 208 affecting the base coupon value 204 applied to a transaction 110. As a first such example, if the base coupon value 204 presents a discount on the cost 112 of the transaction 110, the auxiliary coupon value 208 may increase the discount on the cost 112. As a second such example, if the base coupon value 204 presents an increase in the quality and/or quantity of a product 104, the auxiliary coupon value 208 may specify a further increase in the quality and/or quantity of the product 104 (e.g., the base coupon 202 may specify an quantity increase of 10% of a product 104, and the auxiliary coupon 206 may specify a doubling of the quantity increase of the base coupon 202). As a third such example, if the base coupon value 204 provides a service accompanying a product 104 of the transaction 110, the auxiliary coupon value 208 may increase the duration of the service provided by the base coupon 202 (e.g., an extension of the duration of a warranty of a product 104 that is added to the transaction 110 by the base coupon 202). As a fourth such example, the base coupon value 204 may be altered by the auxiliary coupon values 208 of a plurality of auxiliary coupons 206 applied to the same or different transactions 110 (e.g., several auxiliary coupons 206 each increasing the discount specified by the base coupon 202). Conversely, the auxiliary coupon 206 may alter the base coupon values 204 of several base coupons 202 submitted for the same transaction (e.g., doubling the discounts of several base coupons 202 applied to the same or different transactions 110). As a fifth such example, the auxiliary coupon 206 may be presented concurrently with the base coupon 202 for the transaction 110, or may be presented at a different time for the same transaction 110. In some such scenarios, the auxiliary coupon 206 may even be accepted after the completion of a transaction 110, and may retroactively alter the base coupon value 204 of the base coupon value 202 for the transaction 110 (e.g., by providing a further discount that is credited to the account of the user 108, or by adding additional quantities of a product 104 that may be subsequently delivered to the user 108).

As a fourth variation of this first aspect, the transaction 110 may involve a coupon constraint specifying conditions under which a base coupon 202 and/or an auxiliary coupon 206 may be applied to a transaction 110. As a first such example, the coupon constraint may specify a coupon time deadline, such as a period within which a base coupon 202 may be applied to the transaction 110 (e.g., “base coupon valid until Dec. 31, 2011”). As a second such example, the coupon constraint may specify a transaction participation minimum, e.g., a minimum cost 112 of the transaction 110 or quantity of products 104 in the transaction 110 (e.g., “coupon only valid on purchases of at least $50”). As a third such example, the coupon constraint may specify a maximum coupon redemption count, e.g., a maximum number of base coupons 202 that may be applied to a single transaction 110 (e.g., “only one coupon per transaction”), or a maximum number of uses of a base coupon 202 (e.g., “base coupon only valid for one transaction”). In such scenarios, the transaction server 106 may be configured to verify compliance with the coupon constraint before altering the transaction 110 based on the base coupon value 204 and/or auxiliary coupon value 208. Additionally, in some such scenarios, the auxiliary coupon value 208 may alleviate a coupon constraint of the base coupon 202 (e.g., the base coupon 202 may have expired after a certain deadline, but the auxiliary coupon 206 may extend the deadline for submitting the base coupon 202). Alternatively, the coupon constraint may specify a contingency of the base coupon 202 upon the receipt of the auxiliary coupon 206 (e.g., “base coupon only redeemable if also receiving an auxiliary coupon”), which may be separately collected and submitted to validate the submission of the base coupon 202 for the transaction 110.

As a fifth variation of this first aspect, the base coupon 202 and the auxiliary coupon 206 may be dispensed by vendors 102 to users 108 in various ways. As a first example, the base coupon 202 and auxiliary coupon 206 may be separately dispensed, and a user 108 who collects both coupons may present them for the same transaction 110. As a second such example, the base coupon 202 may be distributed together with the auxiliary coupon 206. As a third such example, the auxiliary coupon 206 may be provided to the user 108 upon receiving the base coupon 202 from the user 108 for a transaction 110, such that the user 108 may present the auxiliary coupon 206 to alter the base coupon value 204 of the base coupon 202 for the same transaction 110, or may present the auxiliary coupon 206 to alter the base coupon value 204 of the same or a different base coupon 202 submitted for a future transaction 110. As a fourth such example, upon completing a transaction 110, the transaction server 106 may dispense to the user 108 an additional coupon that may be applied to a future transaction 110 (e.g., a future transaction 110 with the same vendor 102 for the same product 104 or a different product 104, or for a future transaction 110 with a second vendor 102).

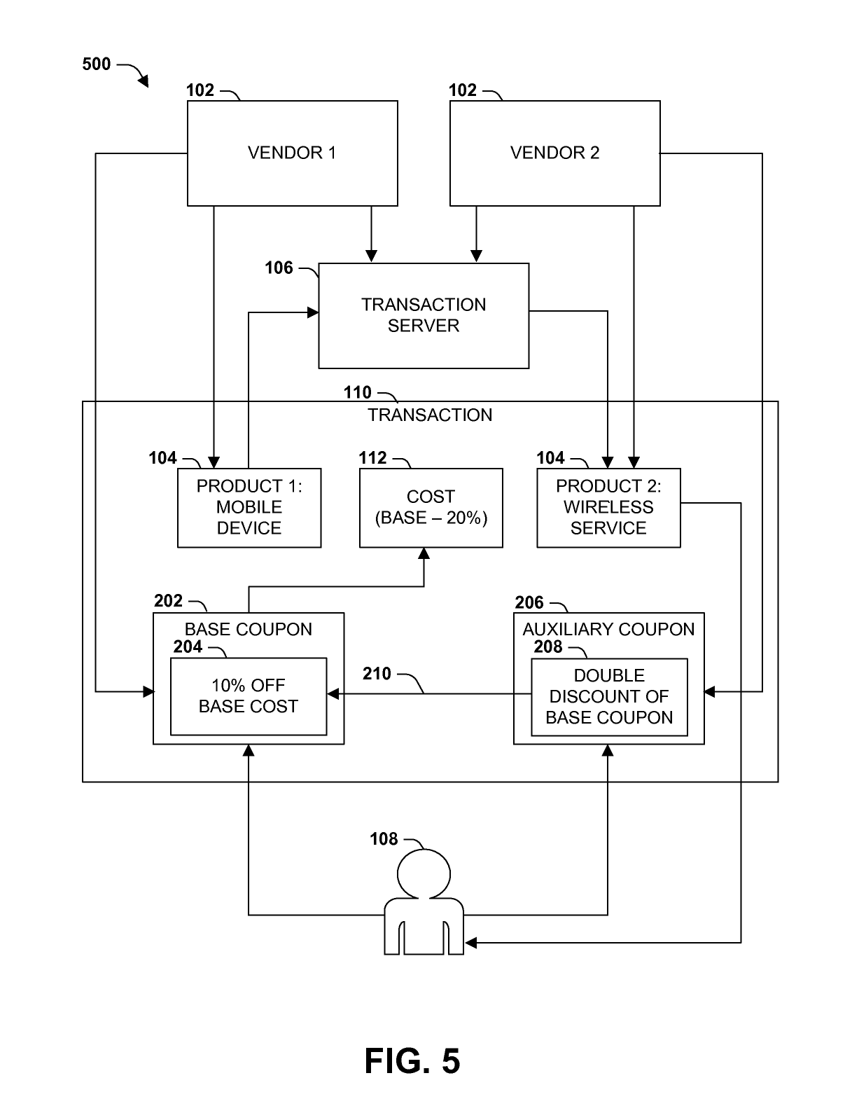

FIG. 5 illustrates a fourth example of this fifth variation of this first aspect, wherein the base coupon 202 and the auxiliary coupon 206 are presented by different vendors 102 involved in the same transaction 110. In this exemplary scenario 500, a user 108 initiates a transaction 110 involving two vendors 102, such as a first vendor 102 of a first product 104 comprising a mobile communications device, and a second vendor 102 of a second product 104 comprising wireless service for the mobile communication device. The products 104 together may represent a cost 112. The user 108 may receive a base coupon 202 from the first vendor 102 providing a base coupon value 204 that reduces the cost 112 of the transaction 110, and may receive an auxiliary coupon 206 from the second vendor 102 providing an auxiliary coupon value 208 that doubles the discount provided by the base coupon value 204 of the base coupon 202. In this manner, the user 108 may receive the base coupon 202 and the auxiliary coupon 206 from different vendors 102 in the same transaction 110, and the transaction server 106 may alter the transaction 110 based on the base coupon value 204 of the base coupon 202 as altered by the auxiliary coupon value 208 of the auxiliary coupon 206. Those of ordinary skill in the art may devise many such scenarios wherein the presently presented techniques may be utilized.

### D2. Social Group Scenarios

Additional variations of the techniques presented herein may relate to the inclusion of a user 108 in a social group, wherein the user 108 may specify associations with other users 108 representing various types of relationships, such as familial relationships, friendships, professional relationships, academic relationships, shared interests, or mutual inclusion in a group or organization. In such scenarios, the transactions 110 may be altered (e.g., the transaction server 106 may be accordingly configured) to utilize the techniques presented herein.

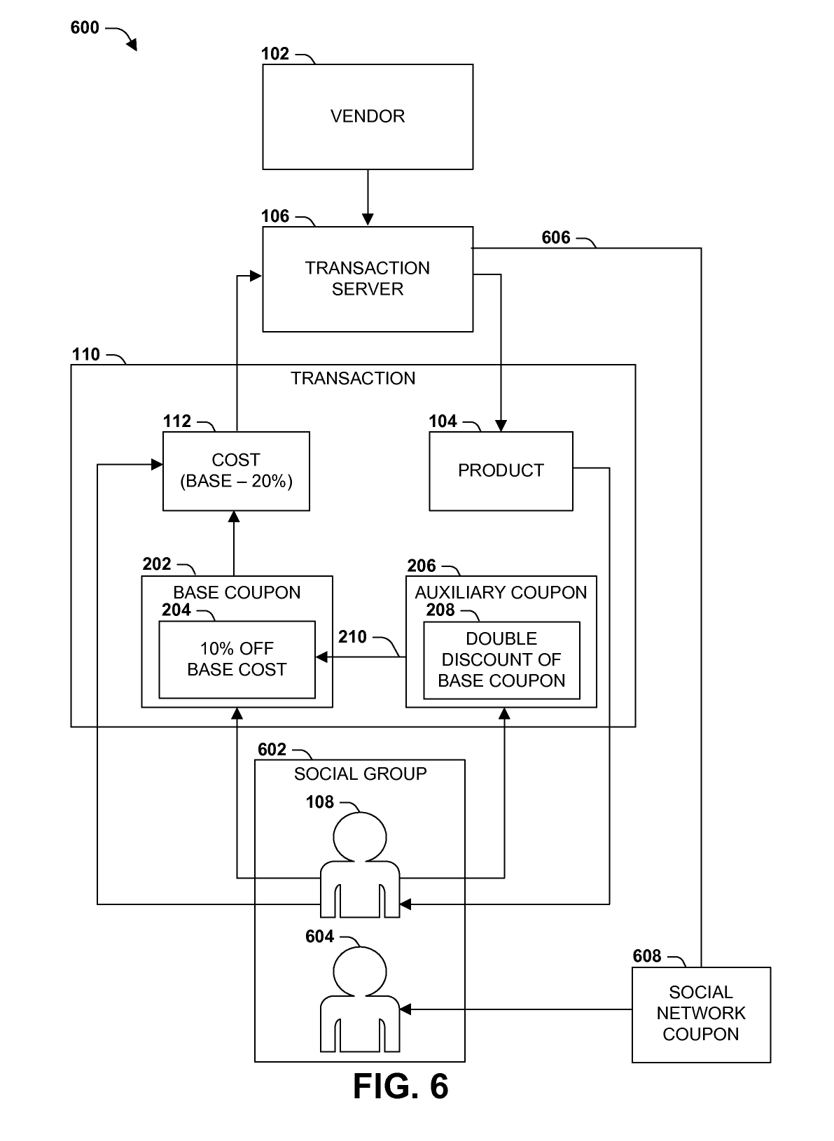

FIG. 6 presents an illustration of an exemplary scenario 600 featuring a first variation of this second aspect. In this exemplary scenario 600, a user 108 completes a transaction 110 involving a product 104 provided by a vendor 102 at a cost 112. The transaction 110 may be completed by a transaction server 106, and may be altered by a base coupon 202 having a base coupon value 204 presented by the user 108, and also an auxiliary coupon 206 having an auxiliary coupon value 208 affecting the base coupon value 204 of the base coupon 202. However, the user 108 may also be involved in a social group 602, such as a social network identifying an association between the user 108 and a second user 604. When the user 108 completes the transaction 110, the transaction server 106 may identify the second user 604 associated with the user 108 through the social group 602, and may present 606 to the second user 604 a social network coupon 608 that the second user 604 may apply to a future transaction 110. Alternatively, the transaction server 106 may present the social network coupon 608 to the user 108, and may permit the user 108 to provide the social network coupon 608 to any of the second users of the same social group 602.

As a second variation of this second aspect, the transaction 110 may involve two or more users 108 of the same social group 602, and the base coupon 202 and/or auxiliary coupon 206 may be submitted for the transaction 110 by the same or different users 108 of the transaction 110. As one such example, the base coupon 202 may be dispensed to a first user 108 of the social group 602, and the auxiliary coupon 206 may be dispensed to a second user 604 of the social group 602. The first user 108 and second user 604 may then initiate a transaction 110 involving both users 108 (e.g., a service provided to both users 108, or a product 104 that is sold to each user 108), and the first user 108 and second user 604 may submit the coupons together to alter the transaction 110 for the benefit of both users 108. As another such example, a first user 108 of the social group 602 may initiate the transaction 110 and present the base coupon 202, and the transaction server 106 may, upon receiving the base coupon 202, dispense the auxiliary coupon 206 to the same first user 108 for delivery to any second user 604 of the social group 602 of the first user 108. If the first user 108 is able to find a second user 604 who is interested in joining the transaction 110, the transaction server 106 may receive the auxiliary coupon 206 from the second user 604, and may alter the transaction 110 according to the base coupon value 204 as altered by the auxiliary coupon value 208 while completing the transaction 110 for both users 108.

As a third variation of this second aspect, if a first user 108 who initiates a transaction 110 persuades a second user 604 of the social group 602 to complete a transaction 110 (e.g., joining the transaction 110 with the first user 108 or a different transaction 110), such as by redistributing an auxiliary coupon 206 to the second user 604, the transaction(s) 110 may be altered based on the base coupon 202 and the auxiliary coupon 206 in a manner that provides a greater benefit to the first user 108 than the second user 604. As a first such example, the first user 108 may initiate a transaction 110 and may persuade a second user 604 within the social group 602 of the first user 108 to join the same transaction 110, and the auxiliary coupon value 208 of an auxiliary coupon 206 submitted for the transaction 110 may provide a greater discount to the first user 108 than for the second user 604. As a second such example, if each of the first user 108 and the second user 604 initiates a transaction 110 for the same product 104, the first user 108 may be charged a first cost that is lower than the base cost of the product 104, and the second user 604 may be charged a second cost that is also lower than the base cost of the product 104, but that is higher than the first cost. This result may be achieved, e.g., by presenting to the first user 108 a social network coupon 608 that, when forwarded to a second user 604 who completes a second transaction 110, reduces the cost 112 of the second transaction 110 to the second user 604, and that further reduces the cost 112 of the first transaction 110 to the first user 108. Moreover, the first transaction 110 involving a base coupon 202 may be completed at a first time, and the second transaction 110 may be completed at a second time that is after the first time, and may involve an auxiliary coupon 206 that affects the base coupon value 204 of the base coupon 202. In order to apply these coupons, the transaction server 106 may charge the first user 108 a transaction cost for the first transaction 110 at the first time in view of a base coupon value 204 of a base coupon 202; and at the second time, may credit the first user 108 for the transaction charge as altered by the base coupon value 204 and the auxiliary coupon value 208 (e.g., refunding the additional discount provided by the auxiliary coupon value 208), thus retroactively altering the base coupon value 204 in view of the auxiliary coupon value 208.

As a fourth variation of this second aspect, the transaction server 106 may notify a social group 602 of the redemption of base coupons 202 and auxiliary coupons 206 that affect one or more users of the social group 602. For example, the transaction server 106 may notify the social group 602 that a user 108 has completed a transaction 110 at a particular discount by applying the base coupon 202 and the auxiliary coupon 206, and/or may notify the other users 108 of the social group 602 of their eligibility to join a pending transaction 110 or to initiate other transactions 110 at a discount through the availability of a social network coupon 608. Such notifications may be delivered in realtime (e.g., via SMS) or in an asynchronous manner (e.g., via email or news feed), and may entice users 108 of the social group 602 to join pending transactions 110 or initiate further transactions 110 with the vendor 102 to utilize such opportunities.

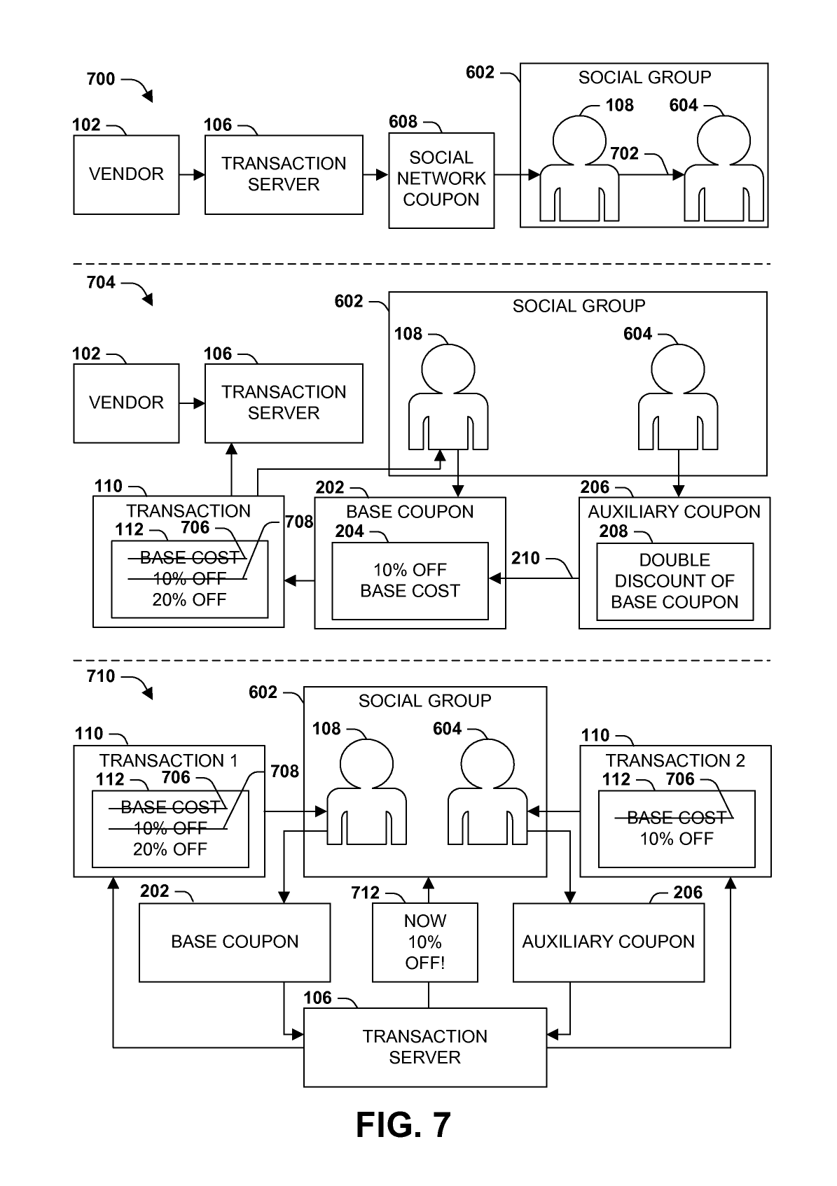

FIG. 7 presents an illustration of an exemplary scenario featuring a notification of a social group 602 of a discount of a transaction 110. In this exemplary scenario, at a first time point 700, a transaction server 106 of a vendor 102 may present a social network coupon 608 to a first user 108 of a social group 602, e.g., where the social network coupon 608 comprises a base coupon 202 that is redeemable by the first user 108 and an auxiliary coupon 206 that is redeemable by a second user 604 of the social group 602. At a second time point 702, the first user 108 may initiate a first transaction 110 with the transaction server 106 and may present a base coupon 202 having a base coupon value 204 that alters a cost 112 of the transaction 110, and the transaction server 106 may alter 706 the cost 112 in view of the base coupon 202. Additionally, the second user 604 of the social group 602 may present to the transaction server 106 the auxiliary coupon 206 that doubles the discount of the base coupon 202 presented by the first user 108, and the transaction server 106 may further alter 708 the cost 112 of the transaction 110 by altering 210 the base coupon value 204 of the base coupon 202 according to the auxiliary coupon value 208 of the auxiliary coupon 206. Additionally, at a third time point 710, the transaction server 106 may notify the social group 602 of the discount 712 provided by the base coupon value 204 of the base coupon 202 redeemed by the first user 108, and may permit any second user 604 within the social group 602 of the first user 108 to initiate a second transaction 110 at the same discount 712. For example, the transaction server 106 may dispense to a second user 604 who has an association with the first user 108 in a social group 602 an auxiliary coupon 206 entitling the second user 604 to apply the base coupon 202 provided by the first user 108 to a second transaction 110, and may notify the social group 602 if a second user 604 completes a second transaction 110. In this manner, the transaction server 106 may enable various users 108 of a social group 602 to redeem base coupons 202 and auxiliary coupons 206 for various transactions 110 according to the techniques presented herein.

### E. Computing Environment

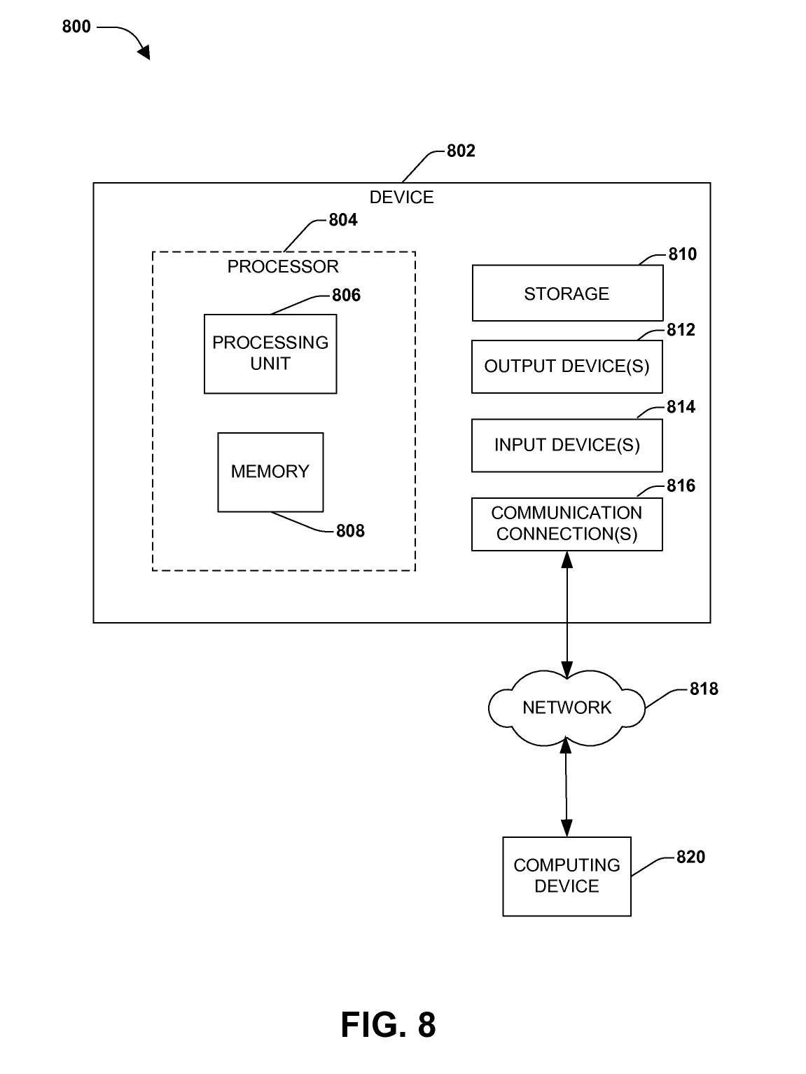

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, tablets, gaming consoles, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 800 comprising a computing device 802 configured to implement one or more embodiments provided herein. In one configuration, computing device 802 includes at least one processing unit 806 and memory 808. Depending on the exact configuration and type of computing device, memory 808 may be volatile (such as RAM, for example), non-volatile (such as ROM, flash memory, etc., for example) or some combination of the two. This configuration is illustrated in FIG. 8 by dashed line 804.

In other embodiments, device 802 may include additional features and/or functionality. For example, device 802 may also include additional storage (e.g., removable and/or non-removable) including, but not limited to, magnetic storage, optical storage, and the like. Such additional storage is illustrated in FIG. 8 by storage 810. In one embodiment, computer readable instructions to implement one or more embodiments provided herein may be in storage 810. Storage 810 may also store other computer readable instructions to implement an operating system, an application program, and the like. Computer readable instructions may be loaded in memory 808 for execution by processing unit 806, for example.

The term “computer readable media” as used herein includes computer storage media. Computer storage media includes volatile and nonvolatile, removable and non-removable media implemented in any method or technology for storage of information such as computer readable instructions or other data. Memory 808 and storage 810 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 802. Any such computer storage media may be part of device 802.

Device 802 may also include communication connection(s) 816 that allows device 802 to communicate with other devices. Communication connection(s) 816 may include, but is not limited to, a modem, a Network Interface Card (NIC), an integrated network interface, a radio frequency transmitter/receiver, an infrared port, a USB connection, or other interfaces for connecting computing device 802 to other computing devices. Communication connection(s) 816 may include a wired connection or a wireless connection. Communication connection(s) 816 may transmit and/or receive communication media.

Device 802 may include input device(s) 814 such as keyboard, mouse, pen, voice input device, touch input device, infrared cameras, video input devices, and/or any other input device. Output device(s) 812 such as one or more displays, speakers, printers, and/or any other output device may also be included in device 802. Input device(s) 814 and output device(s) 812 may be connected to device 802 via a wired connection, wireless connection, or any combination thereof. In one embodiment, an input device or an output device from another computing device may be used as input device(s) 814 or output device(s) 812 for computing device 802.

Components of computing device 802 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 802 may be interconnected by a network. For example, memory 808 may be comprised of multiple physical memory units located in different physical locations interconnected by a network.

Those skilled in the art will realize that storage devices utilized to store computer readable instructions may be distributed across a network. For example, a computing device 820 accessible via network 818 may store computer readable instructions to implement one or more embodiments provided herein. Computing device 802 may access computing device 820 and download a part or all of the computer readable instructions for execution. Alternatively, computing device 802 may download pieces of the computer readable instructions, as needed, or some instructions may be executed at computing device 802 and some at computing device 820.

### F. Usage of Terms

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of processing a transaction of a user on a computer having a processor, the method comprising:
executing on the processor instructions configured to:
receive from the user a base coupon presenting a base coupon value altering the transaction;
receive from the user an auxiliary coupon presenting an auxiliary coupon value altering the base coupon value altering the transaction; and
alter the transaction based on the base coupon value of the base coupon as altered by the auxiliary coupon value of the auxiliary coupon.

2. The method of claim 1:
at least one coupon involving a coupon constraint; and
altering the transaction comprising: altering the transaction after verifying the coupon constraints of the coupons.

3. The method of claim 2, the coupon constraint selected from a coupon constraint set comprising:
a coupon time deadline;
a transaction participation minimum; and
a maximum coupon redemption count.

4. The method of claim 1, the instructions further configured to, upon receiving the base coupon from the user, present the auxiliary coupon to the user.

5. The method of claim 1:
the transaction involving at least two vendors;
the base coupon presented to the user by a first vendor; and
the auxiliary coupon presented to the user by a second vendor.

6. The method of claim 1, the base coupon presenting the base coupon value altering the transaction contingent upon receiving the auxiliary coupon.

7. The method of claim 1, the instructions further configured to, upon receiving from the user a second auxiliary coupon presenting a second auxiliary coupon value altering the base coupon value and the auxiliary coupon value, alter the transaction based on the base coupon value of the base coupon as altered by the auxiliary coupon value of the auxiliary coupon and the second auxiliary coupon value of the sec on auxiliary coupon.

8. The method of claim 1, the instructions further configured to, upon altering the transaction based on the base coupon and the auxiliary coupon, present to the user an additional coupon applicable to a future transaction.

9. The method of claim 8:
the transaction involving a first vendor; and
the additional coupon applicable to a future transaction with a second vendor.

10. The method of claim 8:
the user belonging to a social group; and
the additional coupon applicable to a future transaction by users of the social group.

11. The method of claim 1:
the base coupon and the auxiliary coupon offered to users in a social group;
the transaction involving at least two users of the social group;
the base coupon presented for the transaction by a first user of the social group; and
the auxiliary coupon presented for the transaction by a second user of the social group.

12. The method of claim 11, the instructions configured to receive the base coupon and the auxiliary coupon together for the transaction.

13. The method of claim 11, the instructions further configured to, upon receiving the base coupon from the first user, present the auxiliary coupon to the second user of the social group.

14. The method of claim 11, the instructions configured to, upon receiving the base coupon from the first user, present the auxiliary coupon to the first user for presentation to another user of the social group.

15. The method of claim 11, the transaction altered based on the base coupon value as altered by the auxiliary coupon value comprising:
a first cost assessed to the first user that is lower than a base cost of the transaction; and
a second cost assessed to the second user that is higher than the first cost and lower than the base cost of the transaction.

16. The method of claim 15:
the base coupon presented by the first user at the first time;
the auxiliary coupon presented by the second user at a second time after the first time; and
the second cost assessed to the second user higher than the first cost assessed to the first user.

17. The method of claim 11:
the base coupon presented by the first user at a first time;
the auxiliary coupon presented by the second user at a second time that is after the first time; and
the instructions configured to, at the first time, assess for the first user a transaction charge for the transaction based on the base coupon value; and
altering the transaction comprising: at the second time, crediting the first user for the transaction charge altered by the base coupon value of the base coupon as altered by the auxiliary coupon value of the auxiliary coupon value.

18. The method of claim 11, the instructions configured to, upon altering the transaction based on the base coupon value of the base coupon as altered by the auxiliary coupon value of the auxiliary coupon, notify at least one user of the social group of the altering of the transaction.

19. A computer-readable storage device configured to store instructions that, when executed on a processor of a device, cause the device to process a transaction of a user by:
receiving from the user a base coupon presenting a base coupon value altering the transaction;
receiving from the user an auxiliary coupon presenting an auxiliary coupon value altering the base coupon value altering the transaction; and
altering the transaction based on the base coupon value of the base coupon as altered by the auxiliary coupon value of the auxiliary coupon.

20. A method of processing, on a computer having a processor, transactions among vendors and users belonging to a social group comprising at least one individual, the method comprising:
executing on the processor instructions configured to:
offering a base coupon and an auxiliary coupon to users of the social group;
receive from a user a base coupon presenting a base coupon value altering the transaction and comprising at least zero coupon constraints;
receive from the user an auxiliary coupon presenting an auxiliary coupon value altering the base coupon value altering the transaction and comprising at least zero coupon constraints;
verify the coupon constraints of the coupons;
after verifying the coupon constraints of the coupons, alter the transaction based on the base coupon value of the base coupon as altered by the auxiliary coupon value of the auxiliary coupon;
upon receiving from the user a second auxiliary coupon presenting a second auxiliary coupon value altering the base coupon value and the auxiliary coupon value and comprising at least zero coupon constraints:
verify the coupon constraints of the second auxiliary coupon, and
after verifying the coupon constraints of the second auxiliary coupon, alter the transaction based on the base coupon value of the base coupon as altered by the auxiliary coupon value of the auxiliary coupon and the second auxiliary coupon value of the sec on auxiliary coupon; and
upon altering the transaction based on the base coupon value of the base coupon as altered by the auxiliary coupon value of the auxiliary coupon, notify at least one individual of the social group of the altering of the transaction.
